(19) United States
(12) Patent Application Publication
(10) Pub. No.: US 2011/0050892 A1
(43) Pub. Date: Mar. 3, 2011

(54) IMAGE RECORDING AND COLOR MEASURING SYSTEM

(75) Inventors: Oliver Zind, Karlsruhe (DE); Ralph Schweike, Karlsruhe (DE); Stephan Schade, Karlsruhe (DE); Walter Zind, Pfinztal (DE)

(73) Assignee: Oliver ZIND, Karlsruhe (DE)

(21) Appl. No.: 12/989,387

(22) PCT Filed: Apr. 23, 2009
(86) PCT No.: PCT/DE2009/000540

§ 371 Date: Oct. 22, 2010

(30) Foreign Application Priority Data
Apr. 23, 2008 (DE) 10 2008 020 505.2

(51) Int. Cl. H04N 7/18

(52) U.S. Cl. 348/135; 348/E07.085

(57) ABSTRACT

An image recording and color measuring device for recording image data and color data of a surface of an object. The image recording and color measuring device including: at least one camera module with a line sensor; a first lens system associated with the line sensor to focus light rays; at least one color sensor; and a second lens system associated with the color sensor. The image recording and color measuring device recording image data of one point on the surface of the object with the camera module at the same time as color measuring data is recordable for the one point with the aid of the at least one color sensor. A plurality of image data and color data from individual points provide a total volume of image and color data of the object.

### CROSS-REFERENCE TO RELATED APPLICATIONS

This application is a National Stage Application of PCT/DE2009/000540, filed Apr. 23, 2009, which designates the Germany and claims the priority of German Patent Application No. 10 2008 020 505.2, filed on Apr. 23, 2008.

The invention relates to an image recording and color measuring system, in particular an image recording and color measuring system which is suitable for use as print inspection system for inspecting print images.

### BACKGROUND OF THE INVENTION

Various devices are known from the prior art for recording the outer appearance of an object. Two-dimensional reproductions are created with imaging cameras which provide a precise, subjective image of the object. The use of computer technology and using a plurality of the images furthermore make it possible to obtain a three-dimensional representation. Other devices, in turn, permit the imaging of additional parameters for characterizing an object, wherein these include illumination technologies or other technologies which are based on the use of electromagnetic or sound waves for analyzing the structural features of an object. By using several different technologies, which require the use of different devices, it is thus possible to record desired characterizing parameters of an object, for example information relating to the earth's surface and/or its structure, shapes and coloration, or perhaps information concerning the condition of a material.

A defined problem, which also requires the determination of various parameters of an object, is the print inspection for inspecting the quality of printed items that are produced by a printing press. These printed items can include two-dimensional printed items such as magazines or books, but also three-dimensional objects such as cans or barrels. The quality of the print image is essentially determined by its clarity, the respective delimitation of contours, the purity of color, the sharpness and the precise placement one above the other of the successively printed on colors. The four-color printing normally relates to the use of the colors cyan, magenta, yellow and black, wherein additional colors are added for the multi-color printing. These colors must be placed precisely and in the desired manner one above the other, so that the printed image can meet the aforementioned quality parameters. The color register determines the precise superimposition of the aforementioned different print colors. The color register is important not only for the inspection when using the four-color printing technique, but it also represents a quality characteristic during the production of printed products composed of special colors. To determine the quality of a printed item, it is furthermore necessary to realize a true color measurement, meaning to check the uniform quality of the coloration itself throughout the printing process by producing a plurality of printed products while certain settings and variables are dynamic within a narrow range which is nevertheless important for the printing quality The color register difference, meaning the deviation with respect to the superimposition of the colors, must be determined at the same time.

Known printing presses, such as the so-called web-fed printing presses, nowadays use an automatic color register control for which small register marks are also printed on the printing plates, outside of the end format, and are recorded continuously, for example with the aid of a high-performance camera with flash. A corresponding software application, which processes the enormous data traffic from the high-performance camera, identifies the signals caused by the register marks and ensures the corresponding movement of the marks relative to each other, so that an adjustment of the printing plates during the printing operation is possible if the marks are displaced. The alignment of the camera images requires a certain amount of time because of the large amount of data to be processed, wherein this has the disadvantage that a plurality of printed items may already have been generated by the time a worsening of the printing quality is detected and the printing press is correspondingly adjusted. The high-performance camera is furthermore positioned at a distance that depends on its size to the object to be tested, thereby resulting in the danger that not all aspects of the item to be inspected can be recorded optimally from the same angle and leading to distortions or blurring of the recorded image.

The document DE 20 2004 020 463 U1 discloses a system for evaluating the quality of a printed item produced by a printing press, which system can be arranged easily on a printing press and permits the realization of a complex method for evaluating the quality of the printed item in real time during the continuous printing operation in the printing press. The system in particular is designed to overcome the problems of known camera systems which, during the inspection of colored material with the aid of electronic image sensors, in particular color cameras, record image data that do not correspond to the color perception of the human eye. Insofar, it is considered necessary to reconcile the spectral sensitivity distribution of the color cameras used with the sensitivity distribution of the human eye, so that a printed image recorded with such a camera and displayed on a color monitor will not lead to a distorted visual impression.

The document DE 10 2004 029 140 A1 furthermore describes a method for the identification of a so-called single use “with a printed image having flawed quality on a multiple-use printed material.” An image is thus recorded of at least a section of the printed material and data correlating to the recorded image are checked to determine whether the printed material contains a flaw that reduces the quality of the printed image. From the data correlating to the recorded image, an information is generated with reference to the printed material, wherein this information relates to the location of the flaw reducing the quality of the printed image, so that the information relating to the location of the flaw that reduces the quality of the printed image is matched to an information on the position and size of the individual uses arranged on the printed material, wherein the information on the aforementioned parameters is taken from an electronically generated data set. This is designed to prevent that the quality of a printed image is checked without using a reference printed material.

The document DE 10 2006 025 324 A1 furthermore also offers a sensor arrangement which is suitable for recording strip-type printing surfaces along a moving web of print material. With a reduced apparatus expenditure, the goal is to use sensors for detecting the strip-type region, with respect to a spectral density measurement and color control on the basis of print control strips, wherein sections of the printed surface which successively follow each other in the main direction of expansion for the printing surface are projected adjacent to each other onto the matrix sensor, with the aid of optical means.

The patent document DE 41 36 461 C2 furthermore discloses a device and a method for the large-surface image inspection, wherein the device comprises an optical scanning device with a light source and a recording element. The recording element is arranged in such a way that it cooperates with an electronic control and measuring unit as well as a computing and evaluation unit, wherein the electronic control and measuring unit can be synchronized with the running speed of the printed product, using an angle encoder, so that the time sequence for the recording cycles can be controlled in dependence on the web speed and the computing and evaluation unit can control a color adjustment device for the printing press in dependence on a comparison between an actual value and a desired value. This is realized by configuring the recording element by using several parallel-operated area sensors of the CCD [charge-coupled device] type with respectively one matrix-type addressable image recording and storage area, using a line-scanning line device that is arranged transverse to the printing direction. With each area sensor, the data can be displaced with respect to timing and lines and can be read out serially, wherein this can take place prior to the recording cycle of at least one line transfer pulse.

The available prior art clearly shows that the parallel recording of different parameters which determine the outer appearance of an object, such as the inspection of specific printed items with the aid of the presently available print inspection systems has not been solved satisfactorily to this day, despite an enormous apparatus expenditure.

### SUMMARY

Starting with this prior art, it is the object of the present invention to create an improved image recording and color measuring device, as well as an improved method for the simultaneous recording of image data and color data.

It is furthermore the object to create an improved image recording and color measuring system and a correspondingly improved method.

One embodiment of an image recording and color measuring device according to the invention for recording image data and color data of an object surface comprises a camera module and one or several color sensors with corresponding lens systems, advantageously arranged separately, which permit the simultaneous recording of image data and color measuring data of respectively one point on the surface of the object. A multitude of image data and color data, recorded in pairs of each point, provide a totality of image data and color data that advantageously allows making a statement relating to the quality of the recorded and/or measured object. The statement can relate to the coloration itself or also to the material properties of the object if changes in the coloration of the object indicate changes on the surface of the object, given the expectation of a uniform coloration. As a result of the separate processing of the image data and the color data, it is possible to use highly specialized color sensors and/or image-recording modules which advantageously operate with high speed and accuracy. An improved data recording is thus made available which leads to increased reliability and a faster detection of errors, for example when it is used for the print inspection.

A further embodiment relates to a housing which advantageously surrounds the image recording and color measuring device, so as to protect it.

One embodiment describing the image recording and color measuring system according to the invention is advantageously provided with numerous image recording and color measuring devices according to the invention, so that large surfaces, for example a wide printing web or other objects with longitudinal and/or lateral dimensions of several meters, can be subjected to the synchronous image recording and color measuring and the quality of the surfaces of these objects can advantageously be examined and analyzed.

Another embodiment of the invention relates to the use of the inventive image recording and color measuring system as a print inspection device which is suitable for checking the quality of an image printed onto an object, either during the running process for producing the printed image or immediately thereafter. For this, the image recording and color measuring device is advantageously provided with separate modules for recording the image data and the color measuring data. Highly sensitive color sensors are used parallel to form a temperature-independent image recording device, such as a line sensor that is part of a camera module, and can simultaneously record image data and color measuring data of a point on the printed image. A multitude of recorded image data and color measuring data, which can respectively be assigned to one point, result in lines of coordinated data sets and finally in a total data set which advantageously makes it possible to check the quality of the printed image.

Another embodiment calls for a light source to be arranged inside the housing that encloses the camera module and the color sensors, or alternatively to be arranged on the housing, for the at least partial illumination of the object. As a result it is advantageously possible to arrange a light source separate from the modules for recording the color data and the image data and to move the light source closer to the object, so that a precise illumination is possible. It is furthermore advantageous that by arranging the light source separate from the camera module and the color module, the heat generated by the light source acts less directly upon the aforementioned modules.

Another embodiment relates to the fact that the line sensor, arranged in the camera module, can simply be a monochrome line sensor which advantageously measures only gray-scale values and insofar records only a reduced data set as compared to the color line sensors which generate a multiple times higher data volume. As a result, a lower storage volume for storing the recorded image data can advantageously be made available.

One embodiment of the method according to the invention for the image recording and color measuring of image data and color data of a surface of an object, which method is realized using an image recording and color measuring device according to the invention, relates to the sequence of steps for recording the image data with the camera module and for recording the color measuring data with the color sensors, so as to provide a total volume of image data and color data from a plurality of image data and color data obtained of individual points and, correspondingly, of lines that are composed of a plurality of points.

A further method relates to the use of the image recording and color measuring system according to the invention for obtaining quality information relating to objects measuring up to several meters in longitudinal or lateral direction or for obtaining information relating to the surface coloration or condition.

A different embodiment of the method according to the invention relates to the use of the inventive devices as print inspection devices for the inline inspection of an image printed onto an object. This method is advantageously used to simultaneously record image data of a point on the printed image, using the camera module that comprises the line sensor, and color measuring data with the aid of one or several color sensors, wherein the print image is composed of a plurality of points. As soon as the data for this point are recorded, the aforementioned step is repeated for the following point, so that a plurality of image and color data are advantageously recorded for each individual point, thereby making available a total volume of image and color data which advantageously allows checking the quality of the print image.

These and other advantages are obvious from the following description.

### BRIEF DESCRIPTION OF THE FIGURES

The reference to the Figures in the description serves to support the description. Objects or parts of objects which are essentially the same or similar can be given the same references. The Figures are only intended as schematic representations of the embodiments of the invention. in the Figures show:

FIG. 1 a longitudinal section through the print inspection device and an object arranged in front of it;

FIG. 2 a schematic, perspective view of the print inspection device;

FIG. 3a an image recorded with the image-recording module; and

FIG. 3b the associated data obtained with the aid of color sensors of the same print image as shown in FIG. 3a.

### DETAILED DESCRIPTION

To clarify some of the terms used herein, we want to explain how these are to be understood. An image recording and color measuring device as described herein relates to a device using two separate technologies for measuring the color and for recording images which need only be displayed as gray-scale values. A system of this type differs in essential points from a color camera since it carries out a separate measuring of the aforementioned, completely different parameters and combines the synchronously recorded color data and image data to make available a data set pair. Image recording in the present case means the recording of contours and contrasts and can, but does not have to comprise colors, without providing a statement on the quality of the color or its intensity.

When measuring a point having a diameter of a few μm and/or μm², such as a few mm and/or mm², but which can also have a diameter in the cm and/or cm² range, it is possible on the one hand to record image data for said point and, on the other hand, measure its color data with the aid of different color sensors. The image recording and color measuring data obtained may take the form of a data pair for each point.

A line sensor as described in the above is a light-sensitive and/or a radiation sensitive detector, consisting of a two-dimensional arrangement of photo detectors or other types of detectors. Line sensors can be simple detectors operating on the monochrome principle.

The term lens or lens system as used in the above refers to a device for focusing, bundling or guiding the light.

The image recording and color measuring device according to the invention can furthermore be used advantageously and favorably as a space-saving “print inspection device.” In principle, this is understood to be a device suitable for use with printing machines, such as rotary printing presses, sheet-fed presses and other types of printing presses which are used for the offset printing, the screen printing, the flexographic printing or also for the gravure printing, just to name a few printing techniques, for inspecting the printed image, at least with respect to the color register and the color identity.

The color register control is understood to refer to a checking of the precise placement, one above the other, of color forms which are successively applied to the printing surface during the multi-color printing. A color check refers to a check to determine whether the resulting end color of a colored surface, composed of several printed-on colors, corresponds to the specified end color, wherein the end color can be determined approximately on the basis of standardized color codes. Problems with the color register can be caused, for example, by changes in the running speed of printing cylinders, meaning the faster such a change in the running speed is detected, the faster a printing cylinder can be corrected with the aid of a corresponding control and adjustment device. In the same way, changes in the behavior of the printing paper, the paper-roll winding, the paper storage conditions and the like can be detected and corrected with a timely detection of the printing error, thereby causing a reduction in misprints and waste material.

Those embodiments of the invention for which the color measuring and image recording system is used as a device for the print image inspection relate to realizing an inline inspection of an image that is printed onto an object. In the present case, the inline inspection is understood to mean that the quality of the print image is checked with respect to the color register and the coloration during the printing process inside the printing press. According to the present invention, devices for inspecting the print images can thus advantageously be arranged in the printing press itself. The object onto which the image will be printed is understood for the present case to refer to substrates such as paper, metal or similar materials which can be used for producing magazines, newspapers or also printed-on cans or the like.

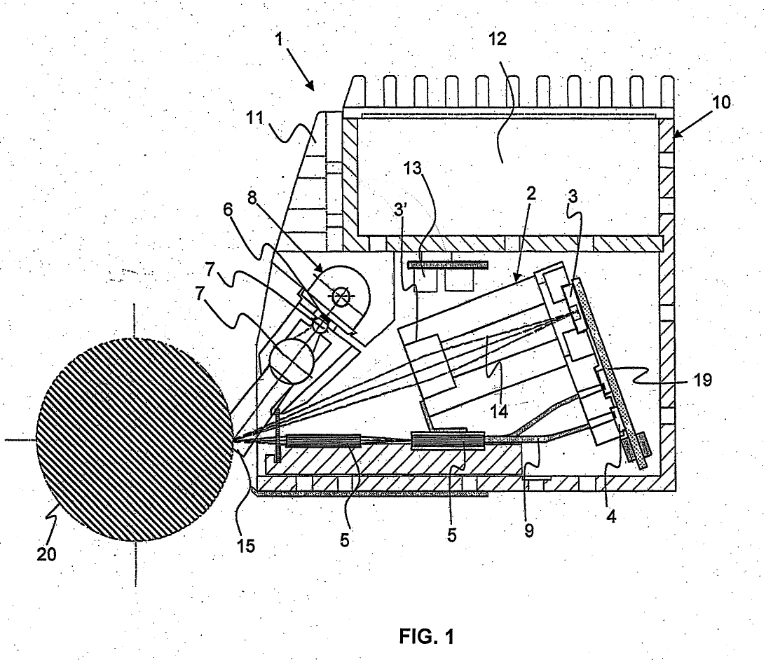

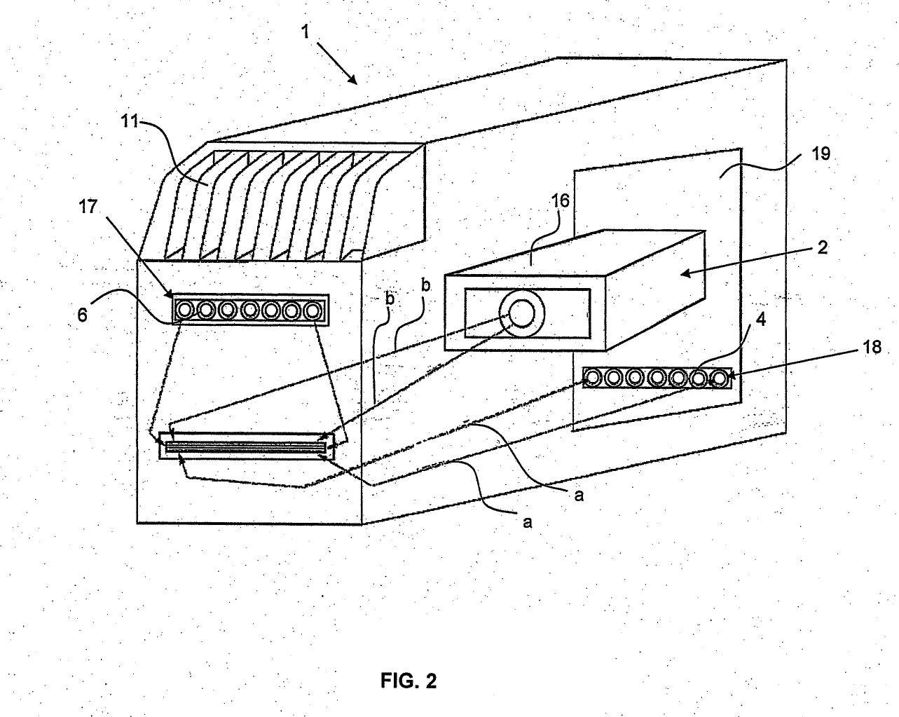

The image recording and color measuring device according to the invention can be used as print inspection device, as shown in FIGS. 1 and 2. FIG. 1 shows the print inspection device 1 provided with a camera module 3 in a camera 2 which comprises a line sensor. A first lens system 3′ for focusing the light is assigned to the line sensor, as indicated by the beam path 14. The print inspection device 1 furthermore comprises several color sensors 4 with a corresponding second lens system 5.

The lens system 5 is advantageously configured such that the glass fibers 9 for conducting the light are guided through metal plates acting as cross-section converters 9′. A side-by side and/or super-imposed arrangement of numerous color sensors 4, containing the respective glass fibers 9, in connection with the elongated lens 5′, can therefore have a light intake and/or a light outlet surface at the end of the glass fibers 9 which points toward the object 20. Corresponding square or round cross sections of the fibers 9 are therefore made available for the color absorption, thereby providing a defined surface having a diameter of a few millimeters or a rectangular basic surface, so that the object surface area to be inspected for the parameters “color” can be determined precisely.

The camera module 3 which, together with the lens system 3′, functions as the camera and is arranged inside a camera housing 16, as well as the color sensors 4, are arranged inside a joint housing 10, such that they are focused on one and the same point or region of the print image to be inspected. Correspondingly, the beam paths 14 and the light waves guided through the glass fibers 9 are guided in such a way through the lens systems 3′, 5 and 7 that they are focused onto a point and/or a line of an object 20. A light control 13 for controlling the illumination with the aid of the light source 6 is helpful for an optimum illumination of the object—at least of the portion of the object surface which is to be subjected to the image recording and color measuring at the respective point in time.

As a result of the arrangement according to the invention, the color sensors 4 and the camera module 3 can simultaneously record image data—with the aid of the camera module 3—and color measuring data—with the aid of the color sensors 4. In this way, image data and color data from a plurality of points are imaged successively and are recorded by the respective recording modules. The detected electromagnetic waves, respectively the signals, are transmitted further via a corresponding data transmission line to an electronic component 12.

As shown in particular in FIG. 2, the beam path of the camera 2 and a plurality of color sensors 4, arranged to form a line and thus representing a color-measuring line 18, as well as a light-source arrangement that is also configured so as to form a line 17 of lights and can consist of space and energy-saving light-emitting diodes, but can also consist of other suitable lighting means, allows an image query in line form, shown with the arrows b, and a color query in line form, as shown with the arrows a, so that a line-by-line scanning of the object surface can be carried out.

FIG. 1 shows that the color sensors 4 and the camera module 3 can be arranged on a printed circuit board 19, wherein corresponding outputs for the color sensors 4 and the camera module 3 are arranged on the printed circuit board and wherein these outputs are connected so as to communicate via signal lines with the electronic component 12. One skilled in the art is familiar with the technology of such a printed circuit board layout. Of course, it is also possible to select wireless communication technology for transmitting the signals between the modules and the electronic component 12.

In the present case, a light source 6 for illuminating the object 20 is shown inside the housing 10. The light source 6 is advantageously oriented such that it provides an ideal illumination of the point or the region of the printed image to be inspected. Of course, one skilled in the art will know that with the present design of the print inspection device 1, the light source 6 in principle can also be arranged outside of the housing 10 or on the housing 10. A lens system 7 focuses the light beam arriving from the light source onto the desired object location. Of course, it is also possible to use a plurality of smaller light sources, perhaps arranged in a row, in place of a larger light source which is held by a holder 8 and is controlled with the aid of the control unit 13.

As a result of the separate recording of image data and color data, which respectively occurs absolutely synchronized with respect to the point, and thus the separate realization of two measuring methods, it is possible to individually optimize the respective device for realizing a measuring method, so as to obtain the smallest possible structural form to be arranged inside the housing 10.

It means that the complete print inspection device 1 can be optimized with respect to the volume it occupies. For example, it is possible to arrange color sensors 4 side-by-side in one row, as shown in FIG. 2. As a result, it is possible to use besides a color camera module also a line sensor as camera module for the camera module 3, which is simply a monochrome line sensor and insofar only records gray-scale values. It simply means that a line sensor can be used which has a lower temperature sensitivity than, for example, a CEMOS (complimentary metal-oxide semiconductor), a NMOS (negative channel metal-oxide semiconductor) or a CCD (charge-coupled device) semiconductor, such as the ones used in color cameras, which provide different color data at different temperatures. On the other hand, using a monochrome camera as in the present case has the advantage that this camera operates at a high speed and has a considerably higher resolution, as compared to the above-mentioned cameras which are configured with semiconductors, thereby achieving a fast and precise image resolution. The required color data is advantageously obtained with the aid of a plurality of color sensors which can be commercially available color sensors. Without wanting to restrict the invention, exemplary color sensors of this type can be provided with a YXZ tri-stimulus output which makes it possible to directly process the recorded data further with a spectral evaluation, for example with the aid of CIELAB. Not required insofar is a so-called RGB (red, green, blue color) output, such as the one used for cameras which simultaneously record image data and color data and which make more difficult a corresponding spectral evaluation.

Of course, the so-called RGB color sensors can also be used, in the same way as spectral sensors or other types of sensors that are suitable for the present use.

The recorded data are transmitted to an electronic component 12 which can advantageously store and/or further process the image data and the color measuring data. To prevent the device from overheating, the housing 10 can be provided with ventilation slits 11 which, as shown in FIG. 1, are arranged advantageously near the light source 6. Of course, the respective ventilation slits 11 can also be arranged at other locations, wherein the ventilation slits 11 are advantageously embodied such that no external light interferes with the recording of the image data by the camera 2, respectively the color sensors 4. It is particularly advantageous that the complete system can be arranged inside a small, elongated housing 10, configured such that it can also be installed in printing devices that are already on the market. Owing to the low depth of the print inspection device 1, wherein the depth refers to the path of the signal entering the housing 10 to a holding device for the camera module 3 and the color sensors 4, the print inspection device 1 according to the invention—and thus also the respective measuring sensors—can be arranged in a printing press in such a way that it can be guided very close to the object 20 to be inspected. As a result, it is possible to carry out an extremely precise inspection.

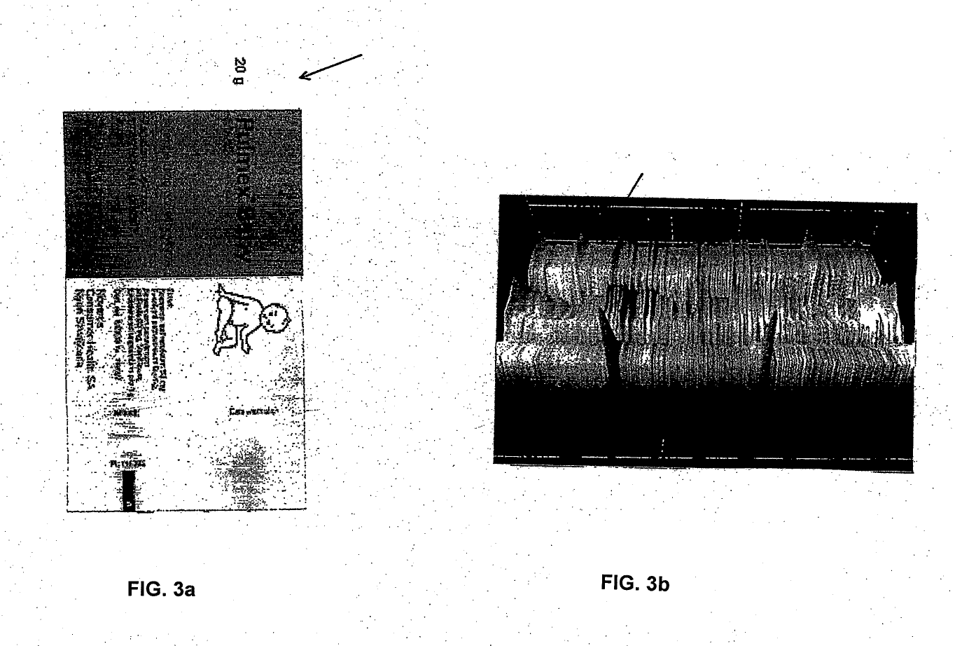

FIG. 3 shows an example of the data which can be recorded with the alternative use of an image module and/or a color measuring module. FIG. 3 contains an image recorded with the image recording module, whereas FIG. 3b displays the associated data which are obtained with the aid of the color sensors from the same printed image as shown in FIG. 3a. It is easy to see how the signal peaks which are detected by the color sensor increase with intensive coloration.

If a plurality of the image recording and color measuring devices according to the invention are arranged adjacent to each other, wherein these are advantageously installed in a joint housing, it is possible to realize a quality inspection inline during the printing operation of objects having a large width—for example printing paper webs measuring up to several meters—or objects with a large circumference, for example barrels, by subjecting them to a color measuring and image recording operation. A system configured in this way can be used for many types of measuring operations because of its small dimensions. The image recording and color measuring devices according to the invention can be installed in different types of housings, in which two or more devices are arranged opposite each other, so as to inspect an object from two sides which are facing away from each other, or also from all three dimensions.

Hardly any limits exist for realizing these inspections, starting with the two-sided print inspection of bottle caps, to check cards or other, substantially larger printed-on or naturally colored objects. One important use also relates to inspecting the quality of the material properties of objects having colored surfaces. Solar panels, for example, which have been scratched or which contain flawed sections, exhibit a different coloration at these flawed locations which can be detected with the system according to the invention. As a result, there are multiple options for using the system.

The method according to the invention is used for the image recording and color measuring of image data and color data of an object surface, using the image recording and color measuring devices according to the invention. The step of simultaneously recording image data with a camera module comprising a line sensor and the associated lens system and recording color measuring data with the aid of at least one or several color sensors with an associated second lens system of a point on the surface of an object, wherein the surface consists of a plurality of points, is repeated until a sufficient set of data is obtained which represents a totality of image data and color data from a plurality of image data and color data of individual points, in accordance with the application purpose, wherein a line-by-line recording of the data is advantageous.

Of course, the method for the image recording and color measuring of image data and color data of an object surface can also be used with an image recording and color measuring system containing a plurality or numerous image recording and color measuring devices. In that case, image data and color measuring data can be recorded simultaneously with several image recording and color measuring devices. When using the method in a printing press for the inline inspection of an image printed onto an object, the printed-on good can be moved past the device or past the system according to the invention, for example by using rotating print cylinders.

### REFERENCE NUMBER LIST

1 print inspection device
2 camera
3 camera module
3′ first lens system
4 color sensor
5 second lens system
5′ elongated lens
6 light source
7 third lens system
8 holder for the light source
9 glass fibers
9′ cross-section converter
10 housing
11 ventilation slit
12 electronic component
13 light control
14 beam path
15 beam path
16 camera housing
17 illumination line
18 color-measuring line
19 printed circuit board
20 object
a color query
b image query

1. An image recording and color measuring device for recording image data and color data of a surface of an object comprising:
at least one camera module with a line sensor;
a first lens system associated with the line sensor to focus light rays;
at least one color sensor; and
a second lens system associated with the color sensor,
wherein image data of respectively one point on the surface of the object is recordable with the camera module at the same time as color measuring data is recordable with the aid of the at least one color sensor, and wherein a plurality of image data and color data from individual points provide a total volume of image and color data of the object.

2. The image recording and color measuring device according to claim 1,
further including a housing inside of which the image recording and color measuring device is arranged.

3. The image recording and color measuring device according to claim 2, wherein the image recording and color measuring device functions as a print inspection device for the inline inspection of an image printed onto an object.

4. The image recording and color measuring device according to claim 1, wherein the image recording and color measuring device includes at least one light source, arranged in and on the housing and a third lens system to focus the light rays to at least partially illuminate the object.

5. The image recording and color measuring device according to claim 4, wherein the first, the second and the third lens systems are arranged so that light rays which pass through the lenses of the systems converge in a point or on a line.

6. The image recording and color measuring device according to claim 1, wherein the line sensor comprises a monochrome line sensor.

7. The image recording and color measuring device according to claim 1, wherein the at least one color sensor comprises one of:
RGB color sensors,
spectral sensors, or
color sensors having a YXZ tri-stimulus output.

8. The image recording and color measuring device according to claim 1, wherein the second lens system comprises at least one of:
an elongated lens
at least one glass fiber for transmitting electromagnetic waves between the point on the object and the at least one color sensor; and
a cross section converter.

9. The image recording and color measuring device according to claim 1, further comprising an electronic component including a data storage and data processing device, wherein the at least one color sensor and the camera module are electronically coupled to communicate with the data storage and data processing device of the electronic component.

10. The image recording and color measuring device according to claim 1, further comprising at least one printed circuit board, wherein the at least one color sensor and the camera module are arranged on the at least one printed circuit board.

11. The image recording and color measuring device according to claim 1, further comprising:
at least one device for synchronizing the simultaneously recorded image data and color measuring data.

12. The image recording and color measuring device according to claim 2, wherein the housing includes at least one opening for heat dissipation.

13. An image recording and color measuring system, comprising:
a housing; and
a plurality of individual image recording and color measuring devices according to claim 1 arranged adjacent to each other or opposite each other inside the housing.

14. The image recording and color measuring system of claim 13, wherein each of the plurality of individual image recording and color measuring devices simultaneously record an image data and color measuring data pair for a plurality of points on the surface of the object, and wherein simultaneously recorded image and color data pairs obtained from the plurality of points provide a total volume of image data and color data of the object.

15. A method for image recording and color measuring of image data and color data of a surface of an object with an image recording and color measuring device that includes at least one camera module with a line sensor, a first lens system associated with the line sensor to focus light rays, at least one color sensor, and a second lens system associated with the color sensor, the method comprising the steps of:
(1) recording image data of a point on the surface of the object with the camera module and the first lens system; and
(2) simultaneously with step (1) recording color measuring data of said point with the at least one color sensors and the associated second lens system; and
(3) repeating the steps (1) and (2) for other individual points on the surface of the object to obtain a total volume of image data and color data from a plurality of individual points of the object.

16. A method for image recording and color measuring of image data and color data of a surface of an object with an image recording and color measuring system comprising a housing and a plurality of image recording and color measuring devices arranged adjacent to each other or opposite each other inside the housing, each image recording and color measuring device including at least one camera module with a line sensor, a first lens system associated with the line sensor to focus light rays, at least one color sensor, and a second lens system associated with the color sensor, the method comprising the steps of:
(1) recording image data of a first point on the surface of an object with the camera module and first lens system of a first image recording and color measuring device;
(2) simultaneously with step (1) recording color measuring data of said first point on the surface of the object with the at least one color sensor and said second lens system of said first image recording and color measuring device to produce a first image and color measuring data pair for said first point;
(3) simultaneously performing steps (1) and (2) with at least another image recording and color measuring device to produce at least another image and color measuring data pair for said first point; and
(4) repeating the steps (1), (2), and (3) for at least a second point on the surface of the object to produce image and color measuring data pairs for the at least second point, wherein steps (1) through (4) produce a total volume of image and color data from a plurality of individual points on the object.

17. The method according to claim 15 including implementing the steps in a printing press for inline inspection of an image that is printed onto an object.

18. The method according to 17, further comprising the step of:
illuminating the image printed onto the object with the aid of a light source that is arranged on or in the housing.

19. The method according to claim 16 including implementing the steps in a printing press for inline inspection of an image that is printed onto an object.

20. The method according to 19, further comprising the step of:
illuminating the image printed onto the object with the aid of a light source that is arranged on or in the housing.

21. A method of inline inspection of an image printed on an object, comprising utilizing the image recording and color measuring device according to claim 1.
